(19) United States
(12) Patent Application Publication
(10) Pub. No.: US 2024/0339942 A1
(43) Pub. Date: Oct. 10, 2024

(54) ELECTROSTATIC DISCHARGE (ESD) HARVEST FOR WEARABLE DEVICES

(71) Applicant: Meta Platforms Technologies, LLC, Menlo Park, CA (US)

(72) Inventors: Pradip Sairam PICHUMANI, Fremont, CA (US); Olga Vladimirovna BARYKINA-TASSA, San Mateo, CA (US)

(73) Assignee: Meta Platforms Technologies, LLC, Menlo Park, CA (US)

(21) Appl. No.: 18/130,586

(22) Filed: Apr. 4, 2023

(51) Int. Cl. H02N 1/06; H02J 7/00

(52) U.S. Cl. CPC H02N 1/06; H02J 7/0042

(57) ABSTRACT

A system for harvesting electrostatic discharge (ESD) energy in wearable devices is described. The system may include a mechanical or piezoelectric based vibration component to generate static electricity (e.g., triboelectricity) from the interaction between dissimilar materials such as by rubbing skin, hair, or fabric against a wearable device material. The generated static electricity may be captured by an electrostatic discharge (ESD) harvester and converted to power that may be used to recharge an on-board battery, at least partially. The static electricity may be alternatively generated by the user interacting with other objects or materials and harvested by the electrostatic discharge (ESD) harvester.

### TECHNICAL FIELD

This patent application relates generally to wearable devices, and in particular, harvesting electrostatic discharge (ESD) energy on a wearable device to provide battery charging power.

### BACKGROUND

With recent advances in technology, prevalence and proliferation of content creation and delivery has increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

Wearable devices, such as augmented reality (AR) eyewear or glasses, smartwatches, handheld controllers, and similar ones may include any number of electrical components. One challenge with such devices may involve powering electrical components. For user-friendly utilization, a wearable device may include a battery or set of batteries, which may be charged through a wired and/or a wireless connection. Each approach may present its own challenges such as location of charging interface, efficiency of charging interface, etc.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an artificial reality system environment including a near-eye display, according to an example.

FIGS. 2A-2C illustrate various views of a near-eye display device in the form of a head-mounted display (HMD) device, according to examples.

FIGS. 3A and 3B illustrate a perspective view and a top view of a near-eye display in the form of a pair of glasses, according to an example.

FIG. 4 illustrates a block diagram of electrostatic discharge (ESD) harvesting in a near-eye display device, according to an example.

FIGS. 5A-5B illustrate an electrostatic discharge (ESD) harvester on a temple of a near-eye display device, according to examples.

FIG. 6 illustrates major components of an electrostatic discharge (ESD) harvester, according to an example.

FIG. 7 illustrates a flow diagram for a method of providing recharge power in a wearable device from an electrostatic discharge (ESD) harvesting, according to some examples.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Wearable devices such as head-mounted display (HMD) devices, near-eye display devices, smart watches, handheld controllers, and similar ones are part of the metaverse, where interactive content such as virtual reality (VR) content, augmented reality (AR) content, and/or mixed reality (MR) content may be provided to users. One challenge with wearable devices is available power. To avoid being tethered to another device or power network, a wearable device may include an on-board battery. However, such a battery may be limited in its capacity and may need to be recharged repeatedly depending on power consumption and battery capacity.

Humans generate electrostatic charge from a number of different sources. Generated electrostatic charge may then be discharged when a person comes in contact with a conductor of a non-conductor charged with opposite electrostatic charge. For example, electrostatic discharge may often happen when the air is drier leading to build up of electrons or interaction of materials with the skin that concentrates the electron generation in the body.

The present disclosure describes a system for harvesting electrostatic discharge (ESD) energy in wearable devices. In some examples, the system may include a mechanical or piezoelectric based vibration component to generate electrostatic charge build-up from an interaction between dissimilar materials such as by rubbing skin, hair, or fabric against a wearable device material. The generated electrostatic charge build-up may be captured by an electrostatic discharge (ESD) harvester and converted to power that may be used to recharge an on-board battery, at least partially. In other examples, the static electricity may be alternatively generated by the user interacting with other objects or materials and harvested by the electrostatic discharge (ESD) harvester.

While some advantages and benefits of the present disclosure are apparent, other advantages and benefits may include increased battery life for a wearable device by providing at least a portion of recharge power. By harvesting electrostatic discharge (ESD) for power generation purposes, electrostatic discharge (ESD) shock risk to the user may also be reduced preventing an unpleasant experience.

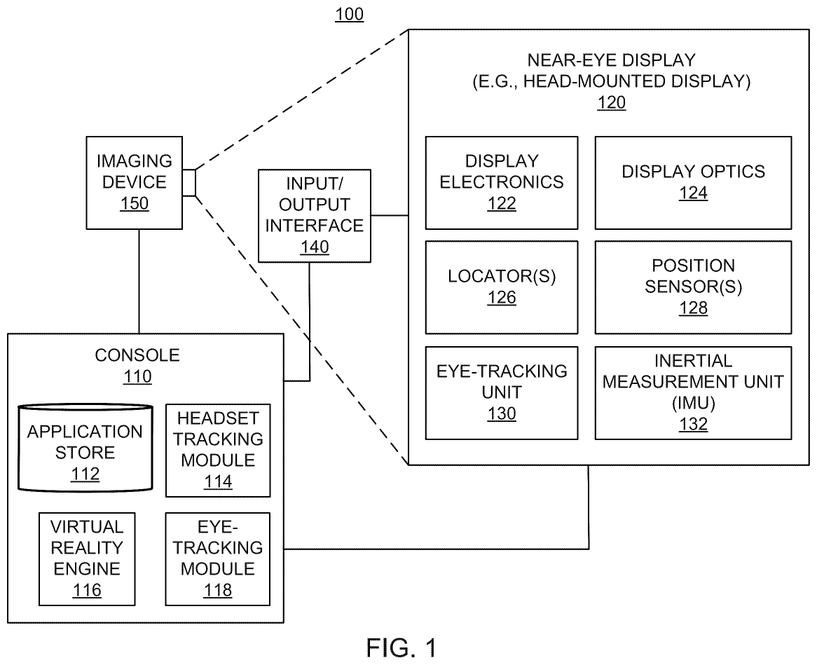

FIG. 1 illustrates a block diagram of an artificial reality system environment 100 including a near-eye display, according to an example. As used herein, a “near-eye display” may refer to a device (e.g., an optical device) that may be in close proximity to a user's eye. As used herein, “artificial reality” may refer to aspects of, among other things, a “metaverse” or an environment of real and virtual elements and may include use of technologies associated with virtual reality (VR), augmented reality (AR), and/or mixed reality (MR). As used herein a “user” may refer to a user or wearer of a “near-eye display.”

As shown in FIG. 1, the artificial reality system environment 100 may include a near-eye display 120, an optional external imaging device 150, and an optional input/output interface 140, each of which may be coupled to a console 110. The console 110 may be optional in some instances as the functions of the console 110 may be integrated into the near-eye display 120. In some examples, the near-eye display 120 may be a head-mounted display (HMD) that presents content to a user.

In some instances, for a near-eye display system, it may generally be desirable to expand an eye box, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular head-mounted display (HMD)) or both eyes (for binocular head-mounted displays (HMDs)). Also, as used herein, an “eye box” may be a two-dimensional box that may be positioned in front of the user's eye from which a displayed image from an image source may be viewed.

In some examples, in a near-eye display system, light from a surrounding environment may traverse a “see-through” region of a waveguide display (e.g., a transparent substrate) to reach a user's eyes. For example, in a near-eye display system, light of projected images may be coupled into a transparent substrate of a waveguide, propagate within the waveguide, and be coupled or directed out of the waveguide at one or more locations to replicate exit pupils and expand the eye box.

In some examples, the near-eye display 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

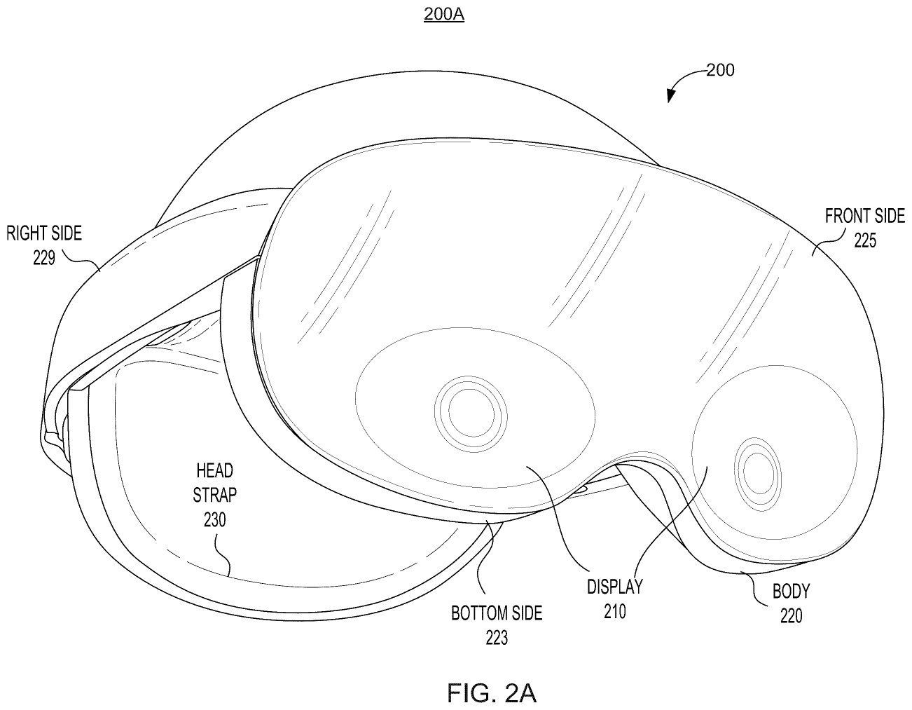

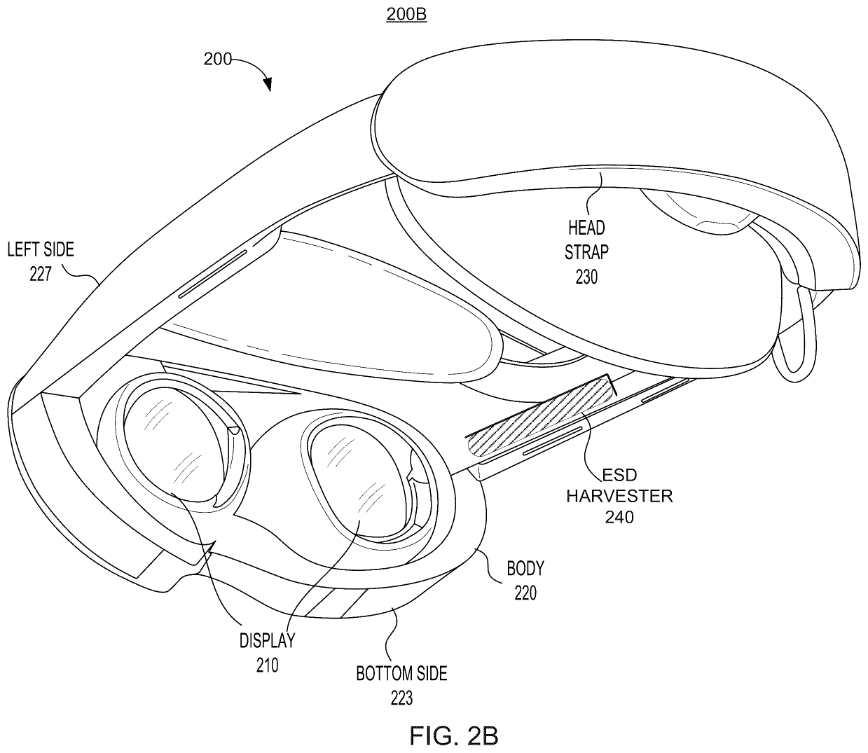

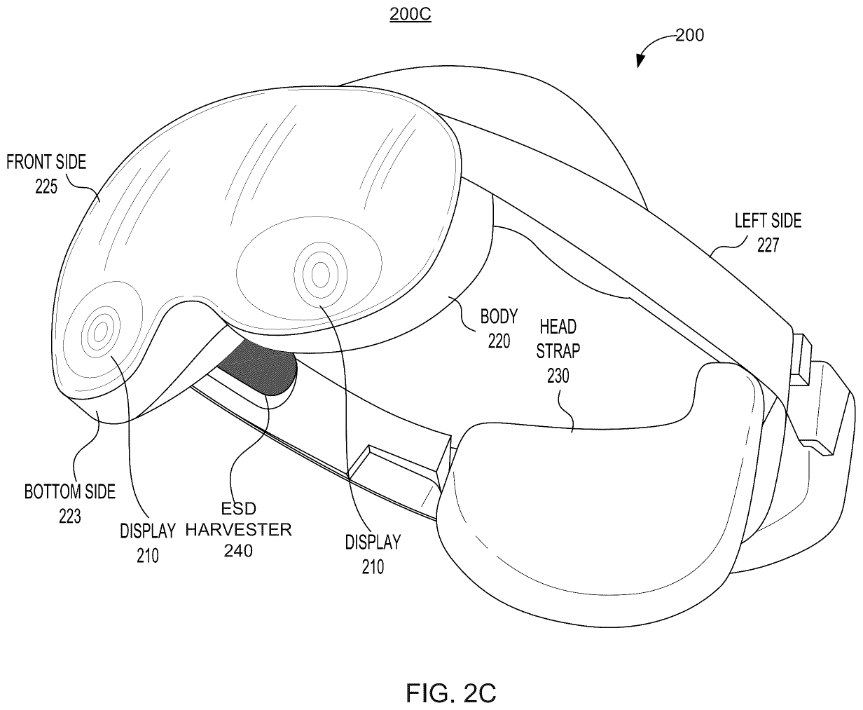

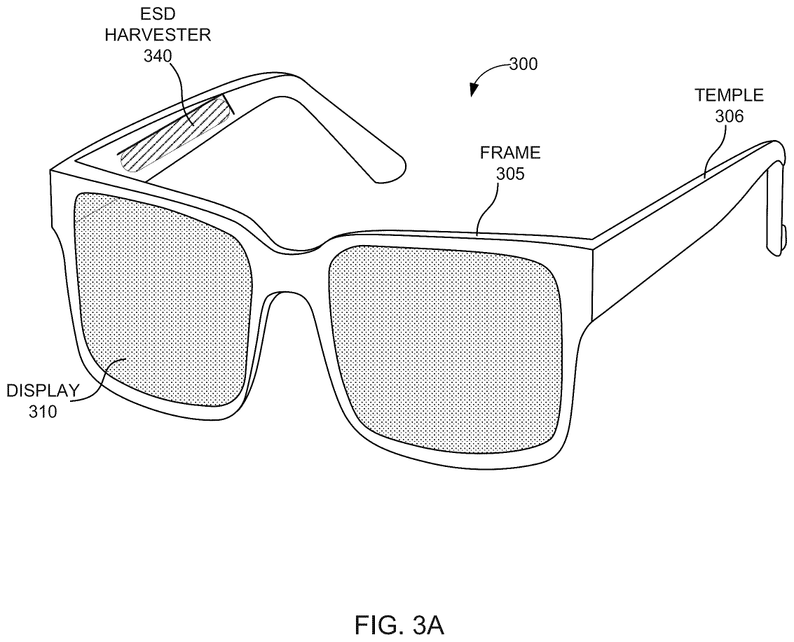

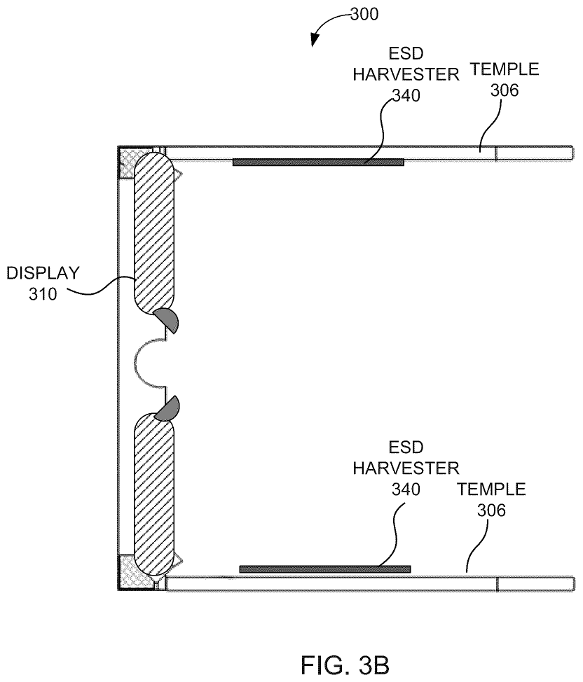

In some examples, the near-eye display 120 may be implemented in any suitable form-factor, including a head-mounted display (HMD), a pair of glasses, or other similar wearable eyewear or device. Examples of the near-eye display 120 are further described below with respect to FIGS. 2 and 3. Additionally, in some examples, the functionality described herein may be used in a head-mounted display (HMD) or headset that may combine images of an environment external to the near-eye display 120 and artificial reality content (e.g., computer-generated images). Therefore, in some examples, the near-eye display 120 may augment images of a physical, real-world environment external to the near-eye display 120 with generated and/or overlaid digital content (e.g., images, video, sound, etc.) to present an augmented reality to a user.

In some examples, the near-eye display 120 may include any number of display electronics 122, display optics 124, and an eye tracking unit 130. In some examples, the near-eye display 120 may also include one or more locators 126, one or more position sensors 128, and an inertial measurement unit (IMU) 132. In some examples, the near-eye display 120 may omit any of the eye tracking unit 130, the one or more locators 126, the one or more position sensors 128, and the inertial measurement unit (IMU) 132, or may include additional elements.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the near-eye display 120 may include a projector (not shown), which may form an image in angular domain for direct observation by a viewer's eye through a pupil. The projector may employ a controllable light source (e.g., a laser source) and a micro-electromechanical system (MEMS) beam scanner to create a light field from, for example, a collimated light beam. In some examples, the same projector or a different projector may be used to project a fringe pattern on the eye, which may be captured by a camera and analyzed (e.g., by the eye tracking unit 130) to determine a position of the eye (the pupil), a gaze, etc.

In some examples, the display optics 124 may display image content optically (e.g., using optical waveguides and/or couplers) or magnify image light received from the display electronics 122, correct optical errors associated with the image light, and/or present the corrected image light to a user of the near-eye display 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 126 may be objects located in specific positions relative to one another and relative to a reference point on the near-eye display 120. In some examples, the optional console 110 may identify the one or more locators 126 in images captured by the optional external imaging device 150 to determine the artificial reality headset's position, orientation, or both. The one or more locators 126 may each be a light-emitting diode (LED), a corner cube reflector, a reflective marker, a type of light source that contrasts with an environment in which the near-eye display 120 operates, or any combination thereof.

In some examples, the external imaging device 150 may include one or more cameras, one or more video cameras, any other device capable of capturing images including the one or more locators 126, or any combination thereof. The optional external imaging device 150 may be configured to detect light emitted or reflected from the one or more locators 126 in a field of view of the optional external imaging device 150.

In some examples, the one or more position sensors 128 may generate one or more measurement signals in response to motion of the near-eye display 120. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display 120 that may be relative to an initial position of the near-eye display 120. For example, the inertial measurement unit (IMU) 132 may integrate measurement signals received from accelerometers over time to estimate a velocity vector and integrate the velocity vector over time to determine an estimated position of a reference point on the near-eye display 120. Alternatively, the inertial measurement unit (IMU) 132 may provide the sampled measurement signals to the optional console 110, which may determine the fast calibration data.

In some examples, the near-eye display 120 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye tracking unit 130 may be able to determine where the user is looking or predict any user patterns, etc.

In some examples, the input/output interface 140 may be a device that allows a user to send action requests to the optional console 110. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display 120 for presentation to the user in accordance with information received from one or more of external imaging device 150, the near-eye display 120, and the input/output interface 140. For example, in the example shown in FIG. 1, the optional console 110 may include an application store 112, a headset tracking module 114, a virtual reality engine 116, and an eye tracking module 118. Some examples of the optional console 110 may include different or additional modules than those described in conjunction with FIG. 1. Functions further described below may be distributed among components of the optional console 110 in a different manner than is described here.

In some examples, the optional console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 110 described in conjunction with FIG. 1 may be encoded as instructions in the non-transitory computer-readable storage medium that, when executed by the processor, cause the processor to perform the functions further described below. It should be appreciated that the optional console 110 may or may not be needed or the optional console 110 may be integrated with or separate from the near-eye display 120.

In some examples, the application store 112 may store one or more applications for execution by the optional console 110. An application may include a group of instructions that, when executed by a processor, generates content for presentation to the user. Examples of the applications may include gaming applications, conferencing applications, video playback application, or other suitable applications.

In some examples, the headset tracking module 114 may track movements of the near-eye display 120 using slow calibration information from the external imaging device 150. For example, the headset tracking module 114 may determine positions of a reference point of the near-eye display 120 using observed locators from the slow calibration information and a model of the near-eye display 120. Additionally, in some examples, the headset tracking module 114 may use portions of the fast calibration information, the slow calibration information, or any combination thereof, to predict a future location of the near-eye display 120. In some examples, the headset tracking module 114 may provide the estimated or predicted future position of the near-eye display 120 to the virtual reality engine 116.

In some examples, the virtual reality engine 116 may execute applications within the artificial reality system environment 100 and receive position information of the near-eye display 120, acceleration information of the near-eye display 120, velocity information of the near-eye display 120, predicted future positions of the near-eye display 120, or any combination thereof from the headset tracking module 114. In some examples, the virtual reality engine 116 may also receive estimated eye position and orientation information from the eye tracking module 118. Based on the received information, the virtual reality engine 116 may determine content to provide to the near-eye display 120 for presentation to the user.

In some examples, the eye tracking module 118, which may be implemented as a processor, may receive eye tracking data from the eye tracking unit 130 and determine the position of the user's eye based on the eye tracking data. In some examples, the position of the eye may include an eye's orientation, location, or both relative to the near-eye display 120 or any element thereof. So, in these examples, because the eye's axes of rotation change as a function of the eye's location in its socket, determining the eye's location in its socket may allow the eye tracking module 118 to more accurately determine the eye's orientation.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

FIGS. 2A-2C illustrate various views of a near-eye display device in the form of a head-mounted display (HMD) device 200, according to examples. In some examples, the head-mounted device (HMD) device 200 may be a part of a virtual reality (VR) system, an augmented reality (AR) system, a mixed reality (MR) system, another system that uses displays or wearables, or any combination thereof. As shown in diagram 200A of FIG. 2A, the head-mounted display (HMD) device 200 may include a body 220 and a head strap 230. The front perspective view of the head-mounted display (HMD) device 200 further shows a bottom side 223, a front side 225, and a right side 229 of the body 220. In some examples, the head strap 230 may have an adjustable or extendible length. In particular, in some examples, there may be a sufficient space between the body 220 and the head strap 230 of the head-mounted display (HMD) device 200 for allowing a user to mount the head-mounted display (HMD) device 200 onto the user's head. For example, the length of the head strap 230 may be adjustable to accommodate a range of user head sizes. In some examples, the head-mounted display (HMD) device 200 may include additional, fewer, and/or different components such as a display 210 to present a wearer augmented reality (AR)/virtual reality (VR) content and a camera to capture images or videos of the wearer's environment.

As shown in the bottom perspective view of diagram 200B of FIG. 2B, the display 210 may include one or more display assemblies and present, to a user (wearer), media or other digital content including virtual and/or augmented views of a physical, real-world environment with computer-generated elements. Examples of the media or digital content presented by the head-mounted display (HMD) device 200 may include images (e.g., two-dimensional (2D) or three-dimensional (3D) images), videos (e.g., 2D or 3D videos), audio, or any combination thereof. In some examples, the user may interact with the presented images or videos through eye tracking sensors enclosed in the body 220 of the head-mounted display (HMD) device 200. The eye tracking sensors may also be used to adjust and improve quality of the presented content. The head-mounted display (HMD) device 200 may also include an electrostatic discharge (ESD) harvester 240 on an inside surface (e.g., right side 229) such that the electrostatic discharge (ESD) harvester 240 can come in contact with the wearer's head (skin, hair, etc.) and generate power from electrostatic discharge (ESD).

In some examples, the head-mounted display (HMD) device 200 may include various sensors (not shown), such as depth sensors, motion sensors, position sensors, and/or eye tracking sensors. Some of these sensors may use any number of structured or unstructured light patterns for sensing purposes. In some examples, the head-mounted display (HMD) device 200 may include an input/output interface for communicating with a console communicatively coupled to the head-mounted display (HMD) device 200 through wired or wireless means. In some examples, the head-mounted display (HMD) device 200 may include a virtual reality engine (not shown) that may execute applications within the head-mounted display (HMD) device 200 and receive depth information, position information, acceleration information, velocity information, predicted future positions, or any combination thereof of the head-mounted display (HMD) device 200 from the various sensors.

In some examples, the information received by the virtual reality engine may be used for producing a signal (e.g., display instructions) to the display 210. In some examples, the head-mounted display (HMD) device 200 may include locators (not shown), which may be located in fixed positions on the body 220 of the head-mounted display (HMD) device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

FIG. 3A is a perspective view of a near-eye display 300 in the form of a pair of glasses (or other similar eyewear), according to an example. In some examples, the near-eye display 300 may be a specific example of near-eye display 120 of FIG. 1 and may be configured to operate as a virtual reality display, an augmented reality (AR) display, and/or a mixed reality (MR) display.

In some examples, the near-eye display 300 may include a frame 305, two temples 306, and a display 310. In some examples, the display 310 may be configured to present media or other content to a user. In some examples, the display 310 may include display electronics and/or display optics, similar to components described with respect to FIGS. 1-2. For example, as described above with respect to the near-eye display 120 of FIG. 1, the display 310 may include a liquid crystal display (LCD) display panel, a light-emitting diode (LED) display panel, or an optical display panel (e.g., a waveguide display assembly). In some examples, the display 310 may also include any number of optical components, such as waveguides, gratings, lenses, mirrors, etc. In other examples, the display 310 may include a projector, or in place of the display 310 the near-eye display 300 may include a projector.

In some examples, the near-eye display 300 may further include various sensors on or within a frame 305. In some examples, the various sensors may include any number of depth sensors, motion sensors, position sensors, inertial sensors, and/or ambient light sensors, as shown. In some examples, the various sensors may include any number of image sensors configured to generate image data representing different fields of views in one or more different directions. In some examples, the various sensors may be used as input devices to control or influence the displayed content of the near-eye display, and/or to provide an interactive virtual reality (VR), augmented reality (AR), and/or mixed reality (MR) experience to a user of the near-eye display 300. In some examples, the various sensors may also be used for stereoscopic imaging or other similar applications.

In some examples, the near-eye display 300 may further include one or more illuminators to project light into a physical environment. The projected light may be associated with different frequency bands (e.g., visible light, infra-red light, ultra-violet light, etc.), and may serve various purposes. In some examples, the one or more illuminator(s) may be used as locators, such as the one or more locators 126 described above with respect to FIGS. 1-2.

In some examples, the near-eye display 300 may also include a camera or other image capture unit. The camera, for instance, may capture images of the physical environment in the field of view. In some instances, the captured images may be processed, for example, by a virtual reality engine (e.g., the virtual reality engine 116 of FIG. 1) to add virtual objects to the captured images or modify physical objects in the captured images, and the processed images may be displayed to the user by the display 310 for augmented reality (AR) and/or mixed reality (MR) applications. The near-eye display 300 may also include an eye tracking camera.

In some examples, one or more electrostatic discharge (ESD) harvesters 340 may be positioned on inside surfaces of the temples 306. The one or more electrostatic discharge (ESD) harvesters 340 may include a mechanical or piezoelectric based vibration component to generate static electricity (e.g., tribocharging) from the interaction between dissimilar materials such as by rubbing skin, hair, or fabric against a wearable device material. The generated static electricity may be captured and converted to power that may be used to recharge an on-board battery, at least partially. In other examples, the static electricity may be alternatively generated by the user interacting with other objects or materials (e.g., a carpet, a clothing item, a seat, etc.) and harvested by the electrostatic discharge (ESD) harvester.

FIG. 3B is a top view of a near-eye display 300 in the form of a pair of glasses (or other similar eyewear), according to an example. In some examples, the near-eye display 300 may include a frame 305 and temples 306 having a form factor of a pair of eyeglasses. The frame 305 supports, for each eye: a fringe projector such as any fringe projector variant considered herein, a display 310 to present content to an eye box, an eye tracking camera, and one or more illuminators. The illuminators may be used for illuminating an eye box, as well as, for providing glint illumination to the eye. The fringe projector may provide a periodic fringe pattern onto a user's eye. The display 310 may include a pupil-replicating waveguide to receive the fan of light beams and provide multiple laterally offset parallel copies of each beam of the fan of light beams, thereby extending a projected image over the eye box.

In some examples, the pupil-replicating waveguide may be transparent or translucent to enable the user to view the outside world together with the images projected into each eye and superimposed with the outside world view. The images projected into each eye may include objects disposed with a simulated parallax, so as to appear immersed into the real-world view.

The eye tracking camera may be used to determine position and/or orientation of both eyes of the user. Once the position and orientation of the user's eyes are known, a gaze convergence distance and direction may be determined. The imagery displayed by the display 310 may be adjusted dynamically to account for the user's gaze, for a better fidelity of immersion of the user into the displayed augmented reality scenery, and/or to provide specific functions of interaction with the augmented reality. In operation, the illuminators may illuminate the eyes at the corresponding eye boxes, to enable the eye tracking cameras to obtain the images of the eyes, as well as to provide reference reflections. The reflections (also referred to as “glints”) may function as reference points in the captured eye image, facilitating the eye gazing direction determination by determining position of the eye pupil images relative to the glints. To avoid distracting the user with illuminating light, the latter may be made invisible to the user. For example, infrared light may be used to illuminate the eye boxes.

In some examples, the image processing and eye position/orientation determination functions may be performed by a central controller, not shown, of the near-eye display 300. The central controller may also provide control signals to the display 310 to generate the images to be displayed to the user, depending on the determined eye positions, eye orientations, gaze directions, eyes vergence, etc.

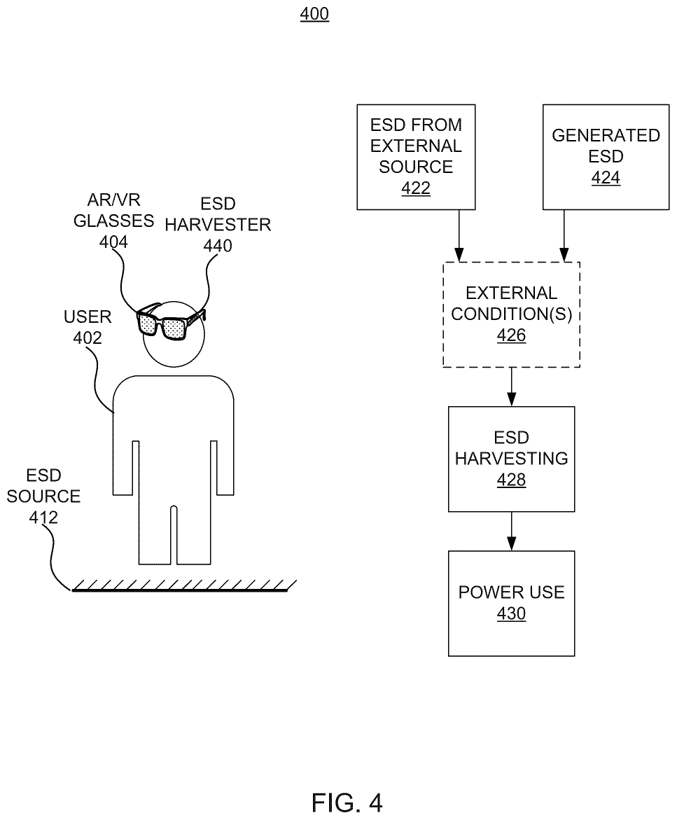

FIG. 4 illustrates a block diagram of electrostatic discharge (ESD) harvesting in a near-eye display device, according to an example. Diagram 400 shows a user 402 wearing augmented reality (AR)/virtual reality (VR) glasses 404, which include an electrostatic discharge (ESD) harvester 440. The user 402 may also receive electrostatic charge from an electrostatic discharge (ESD) source 412. The diagram further shows electrostatic charge from an external source 422 or generated 424 by the electrostatic discharge (ESD) harvester 440. The electrostatic discharge (ESD) harvester 440 may receive information associated with and take into account, optionally, external factors 426 such as humidity of the environment surrounding the user 402, a wetness (or dryness) condition of the user's skin, etc. The electrostatic discharge (ESD) harvester 440 may capture electrostatic charge energy 428, convert to voltage (and current), and provide to a power management circuit for use (430) in one or more components of the augmented reality (AR)/virtual reality (VR) glasses 404 such as recharging a battery. The power management circuit may also include a voltage (or current) level adjuster that may increase or decrease a level of the generated voltage (or current), filter for spikes, and perform other conditioning operations. In some examples, the generated supply voltage may be provided to a battery recharge circuit, which may perform some of the tasks associated with the power management circuit.

As mentioned herein, static electricity charge is generated on human body from a number of different sources. For example, a dry environment may lead to build-up of electrons or interaction of some materials (e.g., polyester) with the skin may concentrate electron generation in the body. The build-up of electrostatic charge may result in electrostatic discharge (ESD) when the body comes in contact with conductor or similar material, where voltages as high as 5000 V to 15000 V may be present in severe conditions. 2000 V to 4000 V may be generated often without being felt as a shock.

In some examples, electrostatic charge build-up in human body may be captured by the electrostatic discharge (ESD) harvester 440 and converted to power that may be used, for example, to recharge an on-board battery or stored in a capacitor. The electrostatic charge build-up may be indirect generation caused by the user coming in contact with certain materials. The electrostatic charge build-up may also be direct generation, where the electrostatic discharge (ESD) harvester 440 may generate electrostatic charge through a vibration (or rubbing motion) by a mechanical or piezoelectric mechanism.

In some examples, a controller on the wearable device (e.g., augmented reality (AR)/virtual reality (VR) glasses 404) may determine when and for how long to activate the electrostatic discharge (ESD) harvester 440. For example, in case of direct generation, the mechanical or piezoelectric mechanism itself may consume power. Thus, the power harvested from electrostatic charge generation may need to exceed the amount of power needed for the mechanical or piezoelectric mechanism. This may depend on a level of humidity in the user's environment (e.g., based on weather data, user's location, etc.), a wetness of the user's skin (e.g., lotion use, perspiration, etc.). A system according to examples, may, in addition to generating power, also reduce risk or level of electrostatic discharge (ESD) shocks, thus enhancing a user experience.

While the example scenario in FIG. 4 is shown with augmented reality (AR)/virtual reality (VR) glasses 404, an electrostatic discharge (ESD) harvester may also be implemented in other wearable devices such as smart watches or similar wrist-worn devices, handheld controllers, and other head-mounted wearable devices.

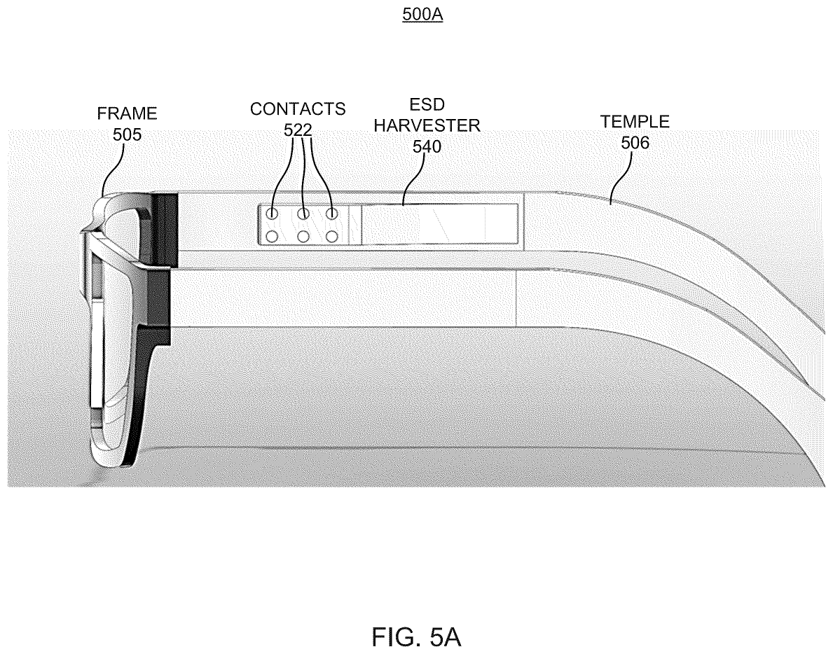

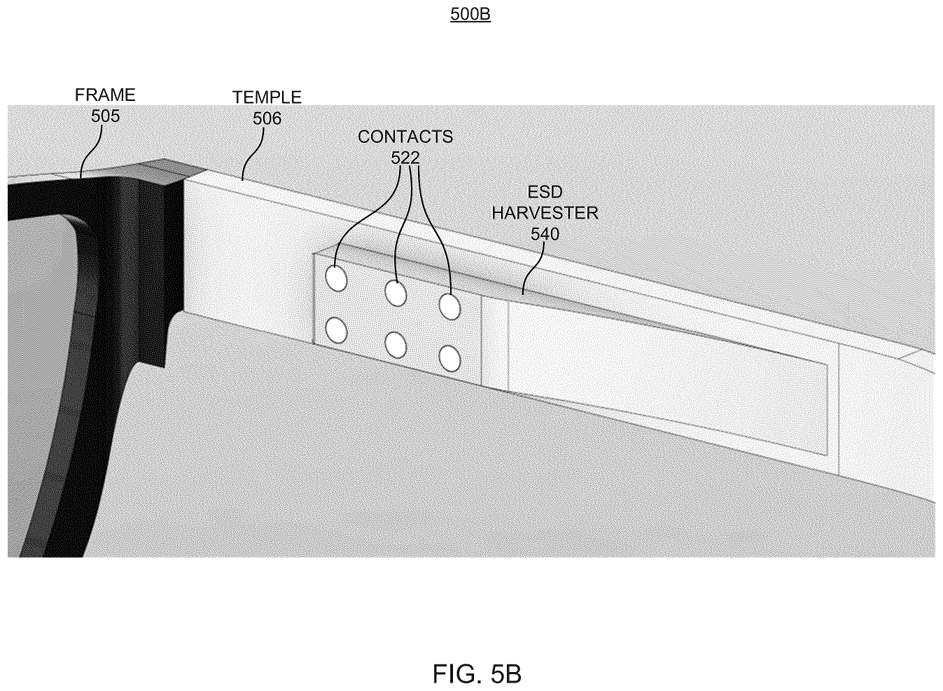

FIGS. 5A-5B illustrate an electrostatic discharge (ESD) harvester on a temple of a near-eye display device, according to examples. Diagram 500A and 500B in FIGS. 5A and 5B show different perspective views of a near-eye display device (augmented reality (AR)/virtual reality (VR) glasses) with an example electrostatic discharge (ESD) harvester 540 on an inside surface of a temple 506 of the near-eye display device.

In some examples, a wearable device may be fitted with more than one electrostatic discharge (ESD) harvester, for example, one on an inside surface of each temple, or even one on an inside surface of the frame 505. The electrostatic discharge (ESD) harvester 540 may include conductive contacts 522, one or more energy storage elements to store the captured voltage, a rectifier, and a power management circuit.

The contacts 522 may be located in proximity to the user's skin and configured to capture generated static electricity. The captured static electricity may be conducted via a diode to ensure that the harvested current flows only in one direction and towards one or more energy storage elements. The energy storage elements may be implemented as supercapacitors that are configured to capture high voltages (e.g., greater than 2000 V). A rectifier conversion module located at the output of the energy storage elements may convert alternating current (AC) to direct current (DC) as well as stepping-down the voltage/current to within safe limits. In some examples, the system may also include a power management integrated circuit (PMIC) to control a battery charging process (e.g., charge duration, spike adjustment frequency, voltage dips, etc.).

The power management integrated circuit (PMIC) may include a timing configuration that takes into consideration: weather data, perspiration, and/or user location to determine a suitable time to generate static electricity. For example, if the user's skin is detected to be wet or the weather is humid (e.g., rain), an efficiency of electrostatic charge generation may not be sufficient. Thus, the system may wait for drier conditions more conducive for electrostatic charge build-up. In some examples, the electrostatic discharge (ESD) harvester may be activated when the wearable device (e.g., augmented reality (AR)/virtual reality (VR) glasses) is activated.

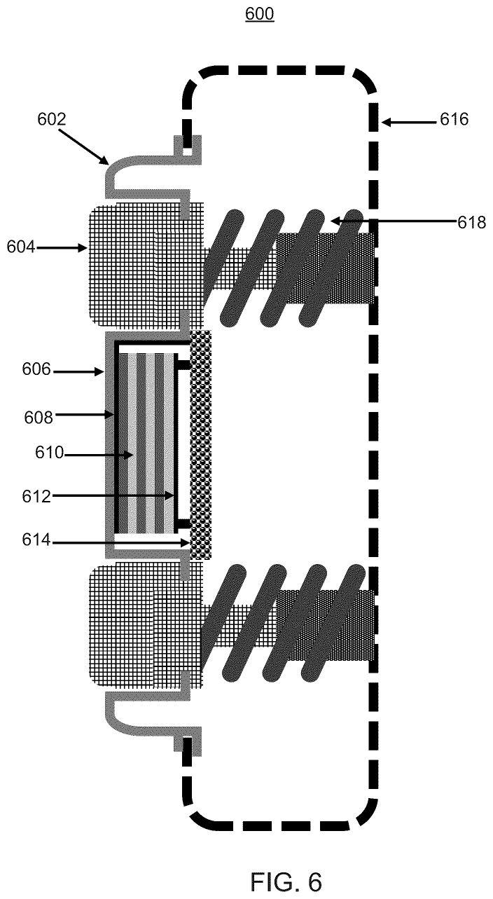

FIG. 6 illustrates major components of an electrostatic discharge (ESD) harvester, according to an example. Diagram 600 shows an outer housing 616 (e.g., temple), contacts 604, a first electrode 608, a second electrode 612, a piezoelectric stack 610, and a rigid flex printed circuit (RFPC) 614. Springs 618 may provide a mechanical push force to the contacts 604 pressing them to the skin of the user. Soft polymeric materials 602 and 606 may insulate the components of the electrostatic discharge (ESD) harvester against environmental elements (e.g., perspiration) while providing flexibility.

The piezoelectric stack 610 may create the vibration to generate direct electrostatic charge build-up. Captured electrostatic discharge voltage may be provided to circuitry (e.g., rectifier, capacitors, etc.) on the rigid flex printed circuit (RFPC) 614 through the first and second electrodes 608, 612. The push force for the contacts 604 may be provided by other elements such as rubber, etc. instead of springs 618. The vibration may also be generated by mechanical components such as a miniature motor, a micro-electromechanical system (MEMS), etc. Some or all of the components discussed in conjunction with diagram 600 may be integrated with the electrostatic discharge (ESD) harvester (e.g., on the rigid flex printed circuit (RFPC) 614) or some of the components may be on other circuit boards in the wearable device.

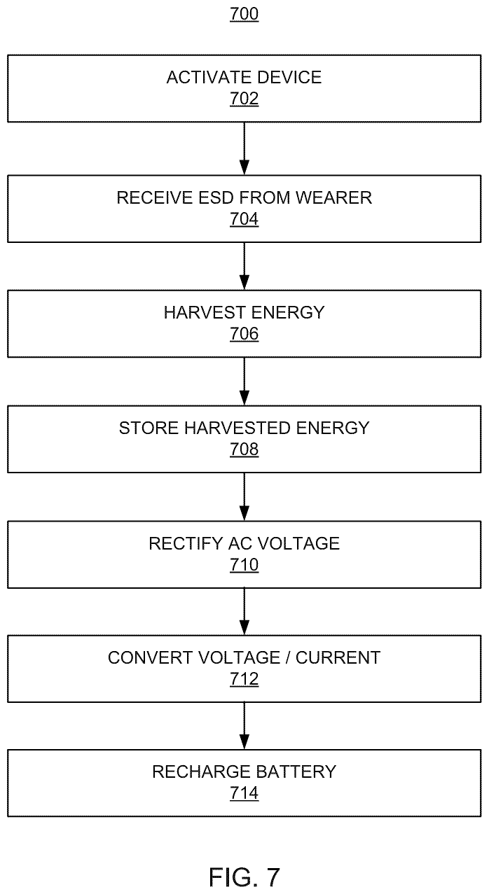

FIG. 7 illustrates a flow diagram for a method of providing recharge power in a wearable device from an electrostatic discharge (ESD) harvesting, according to some examples. The method 700 is provided by way of example, as there may be a variety of ways to carry out the method described herein. Although the method 700 is primarily described as being performed by the components of FIG. 6, the method 700 may be executed or otherwise performed by one or more processing components of another system or a combination of systems. Each block shown in FIG. 7 may further represent one or more processes, methods, or subroutines, and one or more of the blocks may include machine readable instructions stored on a non-transitory computer readable medium and executed by a processor or other type of processing circuit to perform one or more operations described herein.

At block 702, an electrostatic discharge (ESD) harvester incorporated with a wearable device may be activated. Electrostatic charge build-up may be indirect, for example, from contact of material present on the temple arms for with skin. The material may be mechanically stimulated to rub against the user's skin through either a piezoelectric based approach or through mechanical means. The electrostatic charge build-up may also be direct, for example, from user's contact with other materials such as a carpet, clothing items, etc. In case of the direct electrostatic charge build-up, a timing of the device operation may be based on external factors such as humidity, skin wetness, etc.

At block 704, electrostatic discharge (ESD) may be received through conductive contacts at the electrostatic discharge (ESD) harvester. The received electrostatic discharge energy may be passed through a diode to ensure the captured current flows only in one direction (towards the energy storage elements) when the energy is harvested at block 706.

At block 708, harvested energy (i.e., voltage) may be stored in energy storage elements such as supercapacitors. Capacitors capable of capturing high voltages (>2000 V) may be integrated into the wearable device for charge storage.

At block 710, AC voltage may be converted to DC voltage and voltage level adjusted for safety and/or operational purposes (supply voltage for other circuits in the wearable device or recharge voltage for the battery) at block 712. A power management integrated circuit (PMIC) may, for example, manage conversion and adjustment of the voltage.

The voltage generated from the electrostatic discharge (ESD) may be used to recharge an on-board battery at block 714. In other examples, the generated voltage may also be used to supply other circuits in the wearable device.

According to examples, a method of making an electrostatic discharge (ESD) harvester-based power generator for a wearable device is described herein. A system of making electrostatic discharge (ESD) harvester-based power generator for a wearable device is also described herein. A non-transitory computer-readable storage medium may have an executable stored thereon, which when executed instructs a processor to perform the methods described herein.

In the foregoing description, various examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. An electrostatic discharge (ESD) harvesting system for a wearable device, the system comprising:
a vibration element to generate electrostatic charge build-up in a user through a rubbing motion;
at least one conductive contact to capture ESD energy generated by the built-up electrostatic charge from a skin of the user through touch;
at least one energy storage element to store the captured ESD energy; and
a power management circuit to generate a supply voltage for the wearable device from the stored ESD energy.

2. The system of claim 1, wherein the vibration element is to generate the electrostatic charge build-up through tribocharging.

3. The system of claim 1, wherein the ESD energy is further generated by electrostatic charge build-up between the user and an object.

4. The system of claim 1, wherein the power management circuit is further to:
determine a timing of the electrostatic charge build-up and the ESD energy capture based on at least one external factor.

5. The system of claim 4, wherein the at least one external factor comprises at least one of a humidity of an environment around the user or a skin wetness of the user.

6. The system of claim 1, wherein the power management circuit comprises at least one of:
a diode to direct the captured ESD energy to the at least one energy storage element;
a rectifier;
a converter; or
a voltage level adjuster.

7. The system of claim 1, wherein the vibration element comprises a piezoelectric element, a miniature motor, or a micro-electromechanical system (MEMS).

8. The system of claim 1, wherein the power management circuit is to provide the supply voltage to a battery recharge circuit of the wearable device.

9. An augmented reality (AR)/virtual reality (VR) near-eye display device, comprising:
a frame comprising a display;
two temples coupled to the frame; and
an electrostatic discharge (ESD) harvesting system positioned on a user-facing surface of one of the two temples, the ESD harvesting system comprising:
a vibration element to generate electrostatic charge build-up in the user through a rubbing motion;
at least one conductive contact to capture ESD energy generated by the built-up electrostatic charge from a skin of a user through touch;
at least one energy storage element to store the captured ESD energy; and
a power management circuit to generate a battery recharge voltage for the AR/VR near-eye display device from the stored ESD energy.

10. The AR/VR near-eye display device of claim 9, wherein the vibration element comprises a piezoelectric element, a miniature motor, or a micro-electromechanical system (MEMS), and is to generate the electrostatic charge build-up through tribocharging.

11. The AR/VR near-eye display device of claim 9, wherein the power management circuit is further to:
determine a timing of the electrostatic charge build-up and the ESD energy capture based on at least one of a humidity of an environment around the user or a skin wetness of the user.

12. The AR/VR near-eye display device of claim 9, wherein the at least one energy storage element comprises a supercapacitor.

13. The AR/VR near-eye display device of claim 9, further comprising:
another ESD harvesting system positioned on a user-facing surface of the other one of the two temples.

14. The AR/VR near-eye display device of claim 9, wherein the power management circuit is to at least one of convert, rectify, filter, or adjust a level of the generated battery recharge voltage.

15. The AR/VR near-eye display device of claim 9, wherein the ESD harvesting system is activated upon activation of the AR/VR near-eye display device.

16. A method, comprising:
capturing an electrostatic discharge (ESD) from a user through at least one conductive contact on a wearable device;
directing captured ESD energy to an energy storage element;
generating a supply voltage from the ESD energy stored in the energy storage element; and
providing the supply voltage as a recharge voltage to a battery in the wearable device.

17. The method of claim 16, further comprising:
generating electrostatic charge build-up in the user by a vibration element through a rubbing motion, wherein the vibration element comprises a piezoelectric element, a miniature motor, or a micro-electromechanical system (MEMS).

18. The method of claim 17, further comprising:
determining a timing of the electrostatic charge build-up and the ESD energy capture based on at least one of a humidity of an environment around the user or a skin wetness of the user.

19. The method of claim 16, further comprising:
at least one of converting, rectifying, filtering, or adjusting a level of the generated supply voltage.

20. The method of claim 16, wherein directing the captured ESD energy to the energy storage element comprises:
directing the captured energy through a diode.
